(19) United States
(12) Patent Application Publication
(10) Pub. No.: US 2014/0152835 A1
(43) Pub. Date: Jun. 5, 2014

(54) REMOTE MONITORING SYSTEM AND METHOD FOR OPERATING THE SAME

(71) Applicant: AGAIT TECHNOLOGY CORPORATION, New Taipei City (TW)

(72) Inventors: TIEN-CHEN CHEN, NEW TAIPEI CITY (TW); YANG-TZUNG LIEN, NEW TAIPEI CITY (TW); WEI-HAN CHEN, NEW TAIPEI CITY (TW); MING-FENG HSUEH, NEW TAIPEI CITY (TW); MU-CHE LIN, NEW TAIPEI CITY (TW)

(73) Assignee: AGAIT TECHNOLOGY CORPORATION, NEW TAIPEI CITY (TW)

(21) Appl. No.: 13/826,351

(22) Filed: Mar. 14, 2013

(30) Foreign Application Priority Data
Dec. 4, 2012 (TW) 101145542

(51) Int. Cl. H04N 7/18

(52) U.S. Cl. CPC H04N 7/185
USPC 348/158

(57) ABSTRACT

A remote monitoring system and a method for operating the same are revealed. The system gets monitoring images by a camera module of an automatic movable device. Then the monitoring images are output to a cloud storage device through a network module of the automatic movable device. A user at the remote end can receive and display the monitoring devices from the cloud storage device through the network or perform feedback control by a browsing device such as handheld electronic device or computer. Thus household appliances are integrated with cloud and other information media products to provide household monitoring function.

### BACKGROUND OF THE INVENTION

1. Fields of the invention

The present invention relates to a remote monitoring system and a method for operating the same, especially to a remote monitoring system and a method for operating the same that integrate household appliances, cloud systems and multimedia devices.

2. Descriptions of Related Art

In some occasions being monitored by monitoring systems available now such as banks, casinos, airports, military bases, police stations, convenience stores, etc, analogue signals are transmitted in specific area and displayed by fixed loop equipment. Such kind of systems includes a central control room that monitors conditions in different areas.

However, cameras of these monitoring systems are fixed on certain positions. The cameras are either fastened on corners or lenses of the cameras are rotated at a certain speed. There may appear dead angle for monitoring. Moreover, the monitoring cameras disposed at home not only put a lot of stress on residents but also make invaders become aware of their presence being recorded. Thus the invaders will destroy the camera or cover the camera lens.

The images recorded by the conventional monitoring/security system are stored at home or central control rooms. Thus people with bad intention are easy to invade and delete the images. Therefore there is no evidence left for police officers or house owners to check.

Furthermore, the conventional monitoring system is unable to inform users outside home in a real time manner. The camera just records the images and the users don't know changes of conditions within the monitored range. The house owners are too late to stop thieves after coming home.

In addition, there are some products in which the camera is arranged at some household appliances such as movable vacuum cleaner available on the market. However, the images obtained are not stored or transmitted properly. The products only provide users real-time watching and indoor positioning. Thus the products should be used together with staff responsible for monitoring. They are not suitable for household monitoring. The applications of the products have limitations. Moreover, the start timing of the monitoring is uncertain. This is no help in capturing thieves. Most of the monitored images are not stored and used as evidences. Thus it's time and power consuming for users to watch the monitoring images. Furthermore, the products have not setting related to scheduling, warning and image adjustment. The functions of the product are too few to be applied to household monitoring.

### SUMMARY OF THE INVENTION

Therefore it is a primary object of the present invention to provide a remote monitoring system and a method for operating the same that get monitoring images at home by a household automatic movable device. Then the monitoring images are uploaded to and stored in cloud storage space. And users can retrieve the monitoring images from the cloud storage space by smart phones or computers.

It is another object of the present invention to provide a remote monitoring system and a method for operating the same in which users can connect to an automatic movable device for watching the monitoring images after getting internet protocol (IP) address of the automatic movable device by a browsing device such as a smart phone or a computer.

It is a further object of the present invention to provide a remote monitoring system and a method for operating the same that start monitoring and recording automatically after detecting a moving object. Thus the power and storage space are saved and the use efficiency is improved.

It is a further object of the present invention to provide a graphical user interface of a remote monitoring system applied to the above remote monitoring system and suitable for operation of the smart phone or the computer. Users can watch the monitoring images and use additional functions as well as perform feedback control on the automatic movable device through the graphical user interface.

In order to achieve the above objects, a remote monitoring system of the present invention includes an automatic movable device, a cloud storage device, and a browsing device. The automatic movable device includes a camera module for getting a monitoring image, a first network module that transmits the monitoring image and at least one wheel-like body that moves the automatic movable device. The cloud storage device is located at a remote end of a user, used for receiving the monitoring image through network and storing the monitoring image. The browsing device is located near the user and having a second network module and an image display module. The second network module is for retrieving the stored monitoring image from the cloud storage device through the network and the image display module is for displaying the monitoring image. Moreover, a method for operating the remote monitoring system and a graphical user interface of the system are also disclosed. By the method and the graphical user interface, the user's household appliances, cloud devices and information media products available now are integrated to provide household monitoring function.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing structure of an embodiment according to the present invention;

FIG. 2A is a schematic drawing showing transmission and interfaces of an embodiment according to the present invention;

FIG. 2B is a schematic drawing showing an automatic movable device of an embodiment according to the present invention;

FIG. 3 is a flow chart showing steps of a method for operating an embodiment according to the present invention;

FIG. 4 is a login page of a cloud device of an embodiment according to the present invention;

FIG. 5A is a monitoring and control page on a computer of an embodiment according to the present invention;

FIG. 5B is a partial monitoring and control page on a computer of an embodiment according to the present invention;

FIG. 6 is a monitoring and control page on a handheld electronic device of an embodiment according to the present invention; and

FIG. 7 is a preset cleaning schedule page of an embodiment according to the present invention.

### DETAILED DESCRIPTION OF THE PREFERRED EMBODIMENT

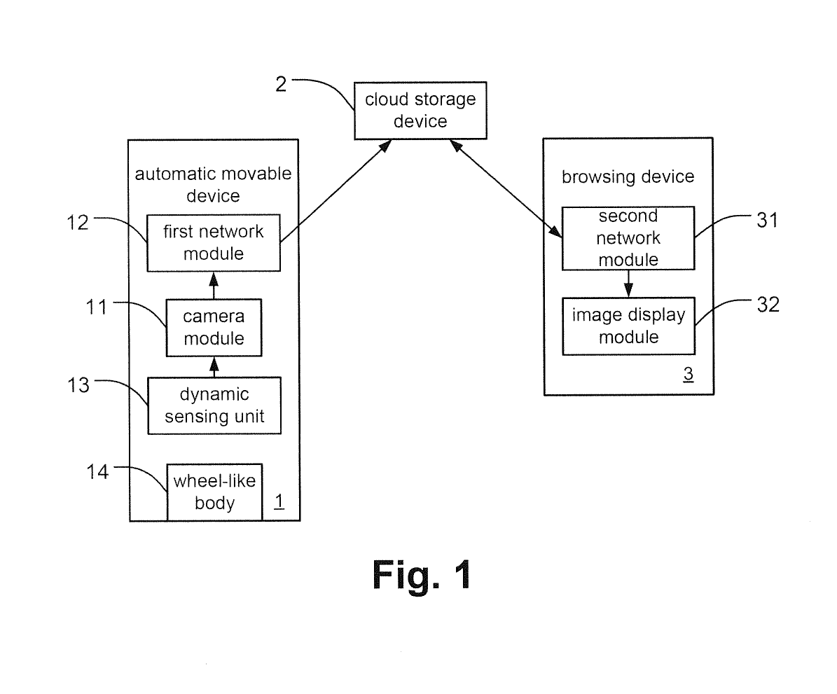

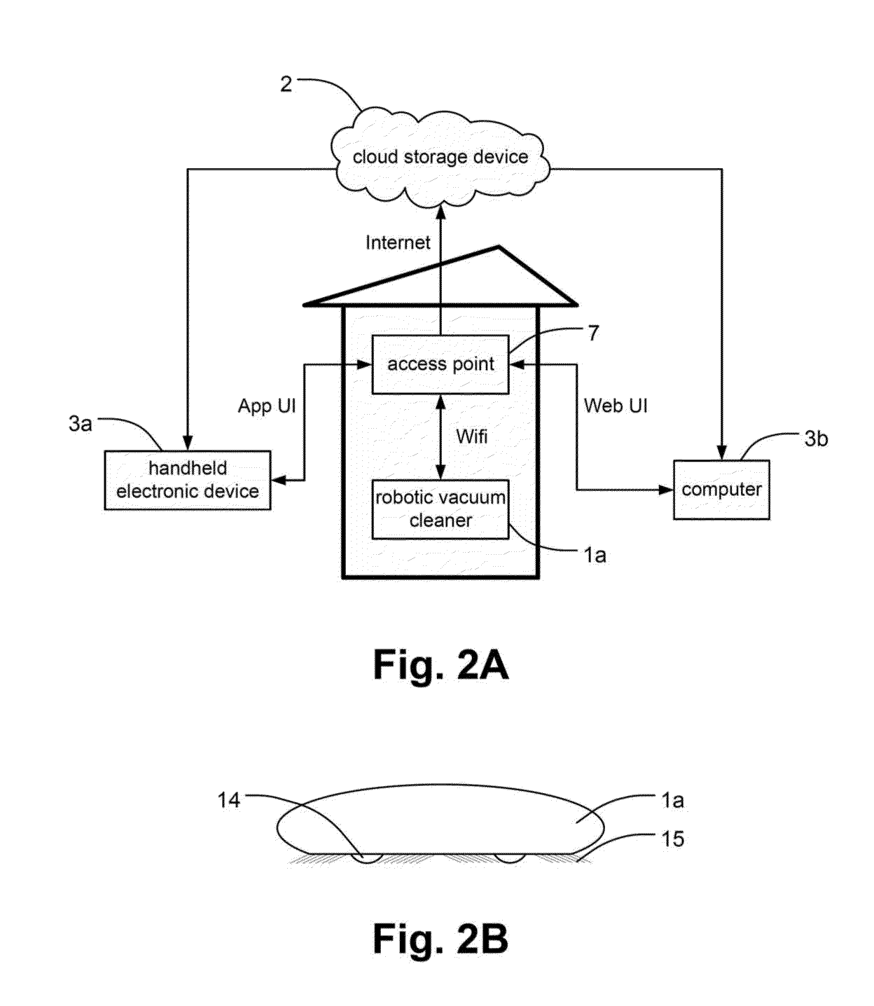

Refer to FIG. 1, FIG. 2A and FIG. 2B, a remote monitoring system of the present invention includes an automatic movable device 1, a camera module 11, a first network module 12, a cloud storage device 2, a browsing device 3, and a second network module 31 and an image display module 32.

The automatic movable device 1 consists of the camera module 11 and the first network module 12 while the browsing device 3 is composed of the second network module 31 and the image display module 32. The cloud storage device 2 is a platform for storage of monitoring images from the automatic movable device 1 and displayed by the browsing device 3.

In order to increase flexibility of the remote monitoring system and break through the limitations of the conventional security/monitoring system being fastened and fixed at the corner, the camera module for taking images is disposed on a movable household appliance that is electrically controlled to move and no labor involved. The preferred automatic movable device 1 is a robotic vacuum cleaner 1a. The robotic vacuum cleaner 1a includes at least one wheel-like body 14 and a cleaner module 15. The flexibility and compact volume of the robotic vacuum cleaner 1a enables it to move freely at home and stay in the corner of the house for monitoring without being found by intruders. The wheel-like body 14 is not limited to a round wheel. It can also be a continuous track or a rolling part, as long as it can move the automatic movable device 1. The cleaner module 15 consists of at least one brush and at least one nozzle outside the machine and other components inside the machine such as fan, filter, dust bag, etc.

The automatic movable device 1 gets images by the camera module 11. The camera module 11 is composed of a high sensitivity wide angle lens and an image processing module. Thus it not only has a wide view but also modifies and adjusts the images obtained in a real-time manner according to conditions of the environment. Therefore a clear view and images with good quality are obtained. The automatic movable device 1 is further disposed with a light sensor and an infrared LED to have automatic light compensation when there is insufficient light for better image recognition.

After getting monitoring images by the camera module 11, the first network module 12 of the automatic movable device 1 transmits the monitoring images to a remote end. The first network module 12 can be wired and wireless. In practice, wireless network module is preferred because the movement range of the automatic movable device 1 is increased and there is no wire hassle.

In a preferred embodiment, the first network module 12 transmits the monitoring images taken by the camera module 11 to the cloud storage device 2. The automatic movable device 1 and the cloud storage device 2 are connected to each other by a network. After receiving the monitoring images, the first network module 12 stores the monitoring images. During the transmission pathway, the first network module 12 transmits the monitoring images to an access point (AP) 7 at home by the Wi-Fi technology, then through cables to get access to the internet and finally reaches the cloud storage device 2. The transmission way of the first network module 12 is not limited to the Wi-Fi technology, other wireless transmission schemes with similar functions can also be applied to the present invention.

The cloud storage device 2 is an application of cloud computing technologies. It's a kind of online storage mode and users can upload their data from their computers to several remote virtual servers that are provided by a third party instead of a specific server and are accessed by several other servers. Thus users can put data online, store it and access it by a specific network interface. The cloud storage device 2 can be cloud storage service provided by ASUSTek Computer Inc. Users can use the storage space after getting their accounts and passwords.

Due to the use of cloud storage, the risk of being hacked and destroyed can be reduced. For example, in general security systems, image data is stored in a memory card mounted in a machine of the system or in a central mainframe at the same building, etc. Thus the data may be stolen or destroyed by people with bad intention for covering their tracks.

In order to review the monitoring images taken by the automatic movable device 1, the user can receive and display the monitoring images by the browsing device 3. The browsing device 3 is located at one end near the user and having the second network module 31 for receiving the monitoring images already being stored in the cloud storage device 2 and the image display module 32 for displaying the monitoring images. In order to get better image display quality, the preferred browsing device 3 can be a handheld electronic device 3a such as a smart phone, a tablet personal computer, a personal digital assistant, or a computer accessible to the internet etc 3b. The computer accessible to the internet are, but not limited to a personal computer or a notebook.

Back to FIG. 1, in order to ensure the camera module 11 of the automatic movable device 1 only moves to get and record monitoring images required as necessary, the automatic movable device 1 further includes a dynamic sensing unit 13 that triggers the camera module 11 to shoot and get monitoring images when it detects that there is something moving within the monitoring range. Thus the power and the space of the cloud storage device 2 can both be saved when the surroundings are safe.

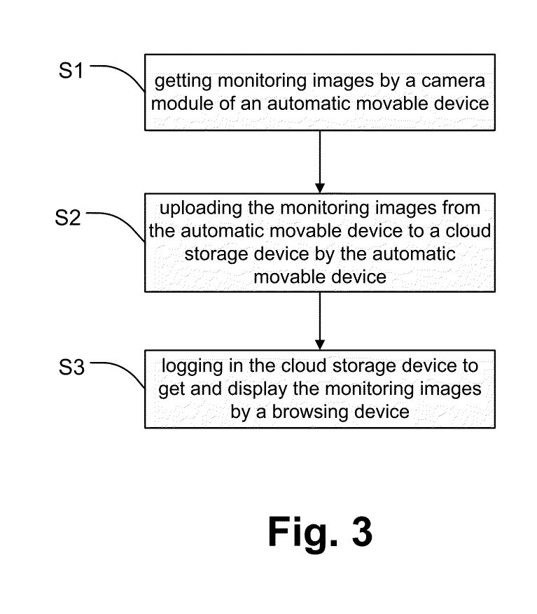

Refer to FIG. 3, a method for operating a remote monitoring system of the present invention includes following steps:

Step S1: getting monitoring images by a camera module of an automatic movable device;
Step S2: uploading the monitoring images from the automatic movable device to a cloud storage device by the automatic movable device; and
Step S3: logging in the cloud storage device to get and display the monitoring images by a browsing device.

This method works based on the hardware structure of the remote monitoring system mentioned above. In the step S1, before getting monitoring images by a camera module 11 of an automatic movable device 1, the camera module 11 is triggered to get the monitoring images only when there is something moving being detected. The detection function is provided by the above dynamic sensing unit 13.

Moreover, the automatic movable device 1 also sends an electronic mail with a picture of the monitoring image to a mailbox address preset by the user for informing the user in a real-time manner when the dynamic sensing unit 13 detects a moving object and triggers the camera module 11 to take the monitoring image. Thus the user can learn that something happens at home. When the user uses the automatic movable device 1 first time, the user connects the automatic movable device 1 to the computer and makes some settings related to the user's information including the mailbox address.

Then in the step S2, the automatic movable device 1 is connected to a network by the first network module 12 thereof for uploading the monitoring images obtained to the cloud storage device 2 to be stored and retrieved. Refer to the step S3, the user can log in the cloud storage device 2 to get and display the monitoring images through the network by the browsing device 3.

By the cloud storage device 2, the user not only displays video recording before, but also watch real-time monitoring images from the automatic movable device 1. At this moment, the user needs to learn internet protocol (IP) address of the network which the automatic movable device 1 at home logged in. This IP can be fixed IP, dynamic IP, or virtual IP.

When the automatic movable device 1 is connected to the network by static IP or virtual IP, the user at the remote end is directly connected to the automatic movable device 1 through this IP. Then the monitoring images are transmitted in a real-time manner. If the automatic movable device 1 is connected to the network by dynamic IP, the connection is set up in a specific way.

Computers use IP addresses to communicate with each other over the internet. Thus no matter connection to internet or e-mail delivery, the user needs to learn the IP address of others to communicate. Most of users use dynamic IP at home. That means the IP address changes every time the user connects. In the present invention, in order to get the IP address of the automatic movable device 1, an e-mail is firstly delivered to a mail server of a third party such as Google's Gmail system by the automatic movable device 1. Thus the user learns IP address of the automatic movable device 1 now through the mail box. Then the user at the remote end makes some settings at an interface platform of the cloud storage device 2 through the browsing device 3 to be connected to the automatic movable device 1 for real-time transmission of the monitoring images.

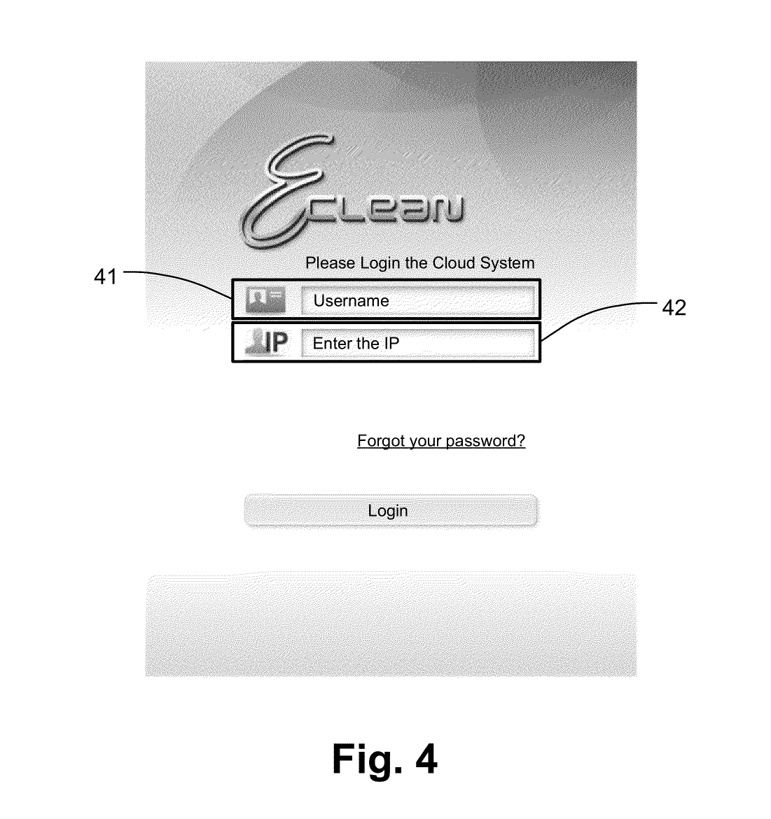

Refer from FIG. 4 to FIG. 7, graphical user interfaces of the browsing device 3 are revealed. An application program is executed by the user through the browsing device 3. First, a cloud login page 4 including an account login box 41 and a password login box 42 is displayed, as shown FIG. 4. For example, the user inputs the account registered and the password to access cloud storage service provided by ASUSTek Computer Inc.

No matter the graphical user interfaces are shown by an application user programming interface (App UI) on the handheld electronic device 3a, or a web user interface (Web UI) on a browser of the computer 3b, both involve the same block components. The only difference between them is the panel size or the operation method has been modified to have different pages or menus.

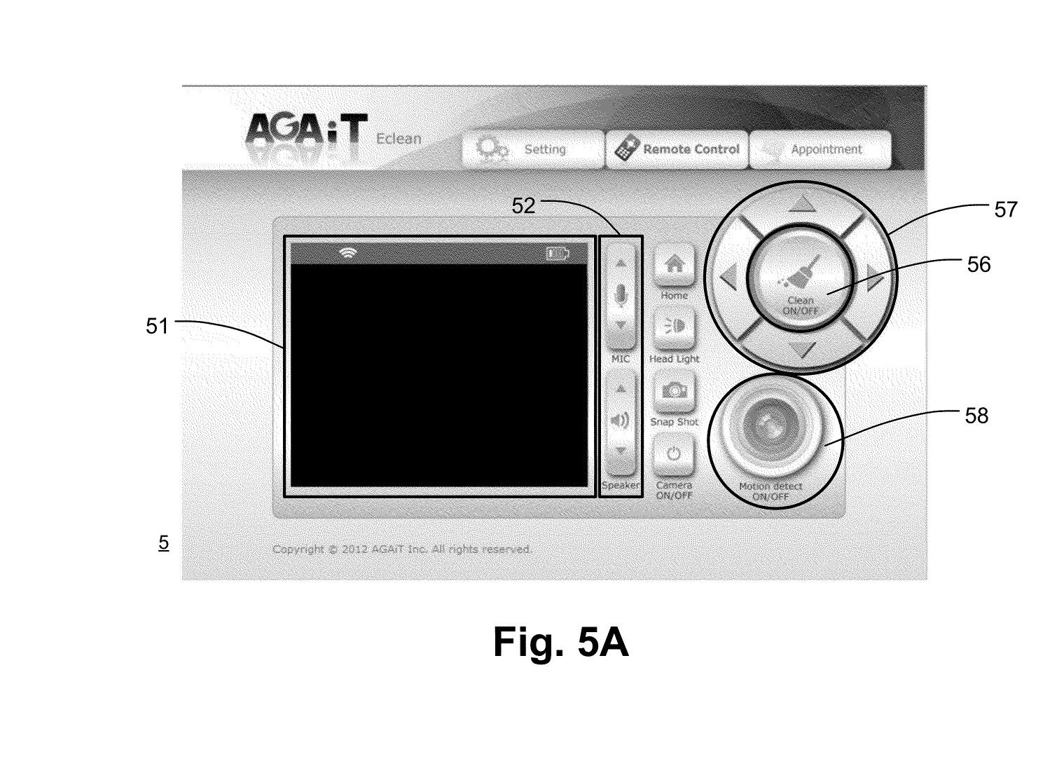

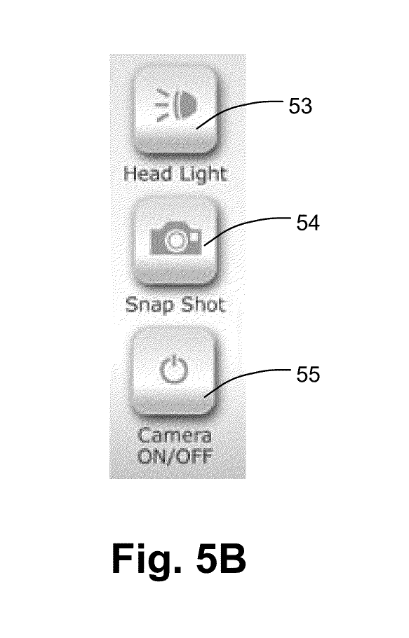

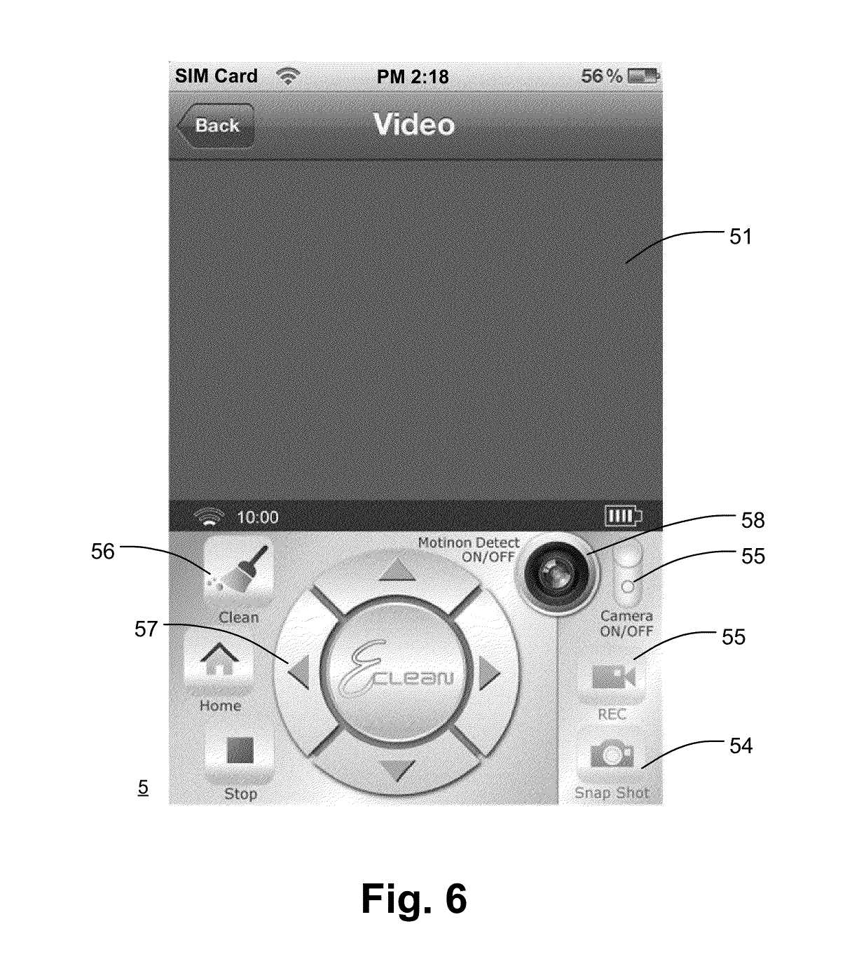

Refer to FIG. 5A, FIG. 5B and FIG. 6, monitoring and control web pages 5 of the present invention are disclosed. The FIG. 5A and FIG. 5B are shown by Web UI while FIG. 6 is shown by App UI. The monitor and control web page 5 includes an image display box 51 for showing the monitoring images, a volume adjustment box 52 for adjusting the amount of volume of the monitoring images displayed or during reception at the remote end, an auxiliary light source member 53 that is an automatic or manual switch of an infrared light emitting diode, a shoot box 54 which can retrieve and store the monitoring image, a video capture switch box 55 that turns on or off the camera module 11 for recording or not recording, a clean switch box 56 for control of the robotic vacuum cleaner 1a to start cleaning, a direction control box 57 for the user to control the movement of the robotic vacuum cleaner 1a manually, and a dynamic detection switch box 58 that controls on/off of the dynamic sensing unit 13 so as to prevent the camera module 11 from being triggered accidentally to record under conditions that are not necessary.

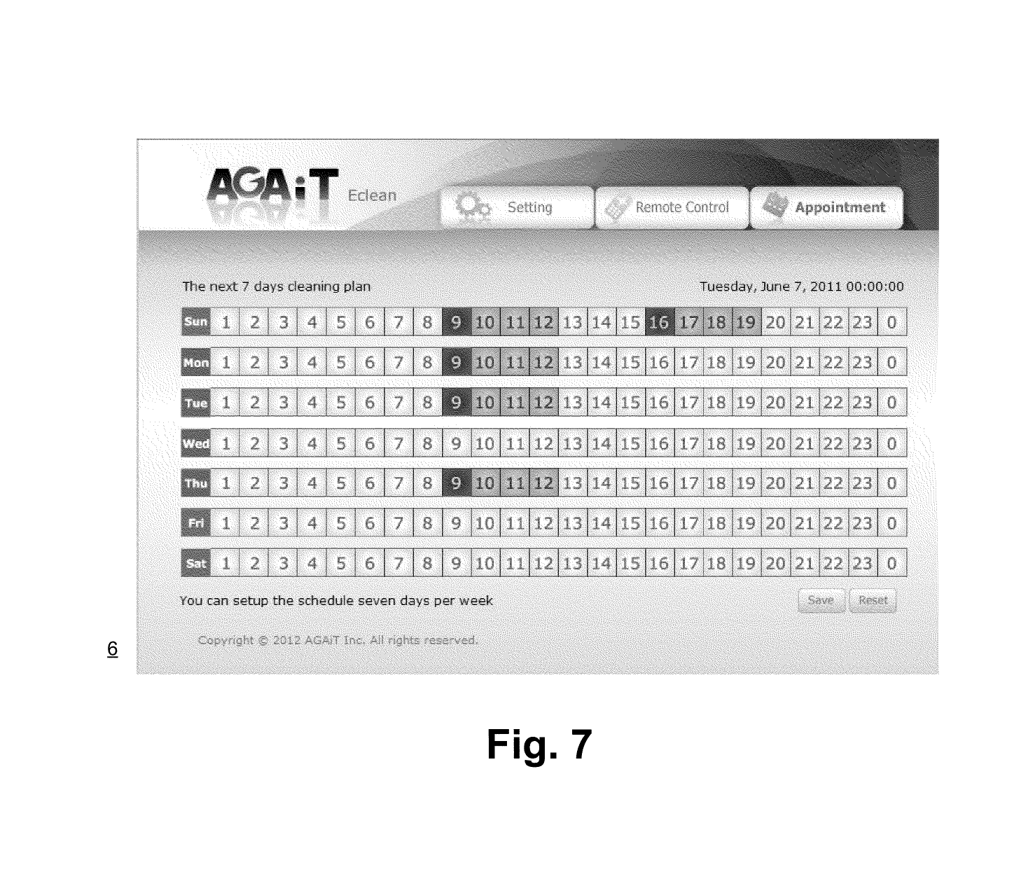

Furthermore, the graphical user interface can be a preset cleaning schedule page 6, as shown in FIG. 7. The time unit is hour and a weekly schedule is provided. Users can setup the schedule and do the cleaning at a preset timing. During the set up process, the maximum number of the time periods per day is three in considering battery life of the robotic vacuum cleaner 1a, the charging time and the possible dirt level. Compared with the present invention, other products can only be set up to perform cleaning once per day.

In summary, the remote monitoring system of the present invention has a plurality of advantages. The present invention takes advantages of the mobility and privacy of the robotic vacuum cleaner sufficiently. The system is also equipped with components such as lens to form the camera module and is integrated with the cloud devices and users' devices including mobile phones, computers, etc through the network system. Thus even users are not at home, they can still get the latest safety information at home easily. Moreover, the system can prevent the monitoring images obtained from being destroyed or deleted and provide users a good interface to perform feedback control. Therefore the remote monitoring system and a method for operating the same are of economic and practical values.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A remote monitoring system comprising:
an automatic movable device having a camera module for getting a monitoring image, a first network module to transmit the monitoring image, and at least one wheel-like body that moves the automatic movable device;
a cloud storage device located at a remote end of an user, receiving the monitoring image through a network and storing the monitoring image; and
a browsing device arranged near the user, having a second network module, receiving the monitoring image from the cloud storage device through the network, and having an image display module for displaying the monitoring image.

2. The system as claimed in claim 1, wherein the automatic movable device further includes a cleaner module that performs cleaning while the automatic movable device is moved.

3. The system as claimed in claim 1, wherein the automatic movable device further includes a dynamic sensing unit that is connected to the camera module; the camera module is triggered to get the monitoring image when the dynamic sensing unit detects a moving object.

4. The system as claimed in claim I, wherein the browsing device is a computer or a handheld electronic device; the browsing device receives the monitoring image from the cloud storage device through the network.

5. The system as claimed in claim 1, wherein the browsing device controls the automatic movable device through the network.

6. A method for operating a remote monitoring system comprising the steps of:
getting a monitoring image by a camera module of an automatic movable device;
uploading the monitoring age from the automatic movable device to a cloud storage device by the automatic movable device; and
logging in the cloud storage device to get and display the monitoring image by a browsing device.

7. The method as claimed in claim 6, wherein the browsing device gets an internet protocol address of the automatic movable device while the monitoring image is displayed by the browsing device in a real time manner through the network.

8. The method as claimed in claim 7, wherein the browsing device gets an internet protocol address of the automatic movable device by sending an electronic mail through the automatic movable device.

9. The method as claimed in claim 6, wherein the camera module is triggered by a dynamic sensing unit when the dynamic sensing unit detects a moving object; the automatic movable device transmits a picture of the monitoring image to the browsing device simultaneously.

10. A remote monitoring system comprising an automatic movable device, a cloud storage device, and a browsing device connected with each other by a network; the automatic movable device having at least one wheel-like body and a cleaner module while the browsing device having a graphical user interface; wherein the graphical user interface includes:
a cloud login page having an account login box and a password login box; and
a monitor and control web page having an image display box, a volume adjustment box, an auxiliary light source member, a shoot box, a video capture switch box, a clean switch box, a direction control box and a dynamic detection switch box.
